(19) United States
(12) Patent Application Publication
(10) Pub. No.: US 2017/0037971 A1
(43) Pub. Date: Feb. 9, 2017

(54) ROBUST METALLIC GASKET FOR LEAK TIGHT FITTINGS IN CRYOGENIC APPLICATIONS

(71) Applicant: NORTHROP GRUMMAN SYSTEMS CORPORATION, FALLS CHURCH, VA (US)

(72) Inventor: Ge Wang, LOS ALAMITOS, CA (US)

(21) Appl. No.: 14/818,589

(22) Filed: Aug. 5, 2015

(51) Int. Cl. F16J 15/08; B64G 1/22

(52) U.S. Cl. CPC F16J 15/0806; B64G 1/22

(57) ABSTRACT

A gasket seal that has particular application for hermetically sealing a helium gas-tight joint for a cryogenic application on a spacecraft. The gasket seal is made of a metal, such as titanium, vanadium, zirconium, erbium or alloys thereof, and/or has an elastic modulus in the range of 0.5-0.7 relative to stainless steel and a coefficient of thermal expansion in the range of 0.5-0.8 relative to stainless steel.

### BACKGROUND

1. Field

This invention relates generally to a metal gasket seal and, more particularly, to a metal gasket seal made of, for example, titanium, vanadium, zirconium, erbium or alloys thereof that each provides a low elastic modulus, a high yield strength, corrosion resistance and a low coefficient of thermal expansion (CTE) to be suitable for preventing helium gas leaks in cryogenic applications on, for example, aerospace vehicles.

2. Discussion

Various systems on board a spacecraft require cryogenic cooling of an object or device. For example, various types of sensors, such as infrared radiation sensors, need to be cryogenically cooled so as to reduce or eliminate thermal noise and allow the sensor to provide the degree of sensitivity desired. In order to provide cryogenic cooling, it is known to provide a storage tank of helium on the spacecraft that delivers the helium to a chiller to provide a super-cooled helium gas to the sensor or other device. Typically, various pipes and tubes direct the helium gas from the storage tank to the chiller and to the sensor, which often requires various fittings to couple ends of the pipes together and to couple the pipes to the storage tank, chiller and the sensor. These fittings need to be leak tight to perform correctly, and as such usually employ seals.

In order to provide gas-tight sealing, elastomeric gasket seals, such as rubber gasket seals, are usually employed that provide a significant compensation to sealing surface irregularities through a large elastic deformation of the seal under a compressive load. A rubber gasket seal meets these objectives because under pressure, rubber gasket seals deform and fill microscopic valleys at the sealing surface, thus drastically reducing the leak rate of gas molecules through the sealed area. However, elastomeric materials cannot be used for cryogenic helium-tight joints. Particularly, elastomeric materials have high out-gassing rates that often contaminate the helium gas. Further, elastomeric materials are highly permeable to helium gas and cannot meet most stringent leak tight requirements. Also, elastomeric materials often become rigid and brittle at cryogenic temperatures.

Metallic gasket seals are therefore the most popular type of gasket material for use in cryogenic helium-tight applications. Typically, these metallic gasket seals are made of stainless steel, however other metals are known to be used, such aluminum, nickel, copper, or alloys thereof. Although stainless steel gasket seals are effective in providing gas-tight sealing for cryogenic applications, often times these gasket seals become less effective over time. For example, under normal use as a result of system vibrations, fitting cycling, temperature expansion, etc., the stainless steel gasket seal may lose its effective sealing making it undesirable for the particular application.

Further, the vast majority of metallic materials do not have a low enough elastic modulus and exhibit poor elastic deformation when used as a gasket seal. As such, known metals for gasket seals are generally not robust enough for cryogenic helium-tight joints.

Low yield strength of a material results in plastic deformation under a high contact pressure at a sealing surface. Known metallic gasket materials typically exhibit a large plastic deformation at the seal surface and as such an irreversible deformation does not ensure long duration gas tightness. Under temperature excursions, plastic deformation cannot recover, thus gradually losing sealing surface contact, where a gasket seal must not be reused after plastic deformation.

Corrosion resistance of a metal gasket seal is required since the seal material is in intimate contact with a seal surface, which is often made of a different metal, such as stainless steel. Galvanic potential differences can lead to localized corrosion to either the gasket or the seal surface.

A proper selection of material CTE for a metal gasket seal is also important, especially for cryogenic applications, since all of the fittings are made at a temperature higher than cryogenic temperatures before being placed into service. Gasket seal materials with a high CTE, such as aluminum and copper, do not ensure a gas-tight joint at cryogenic temperatures because large magnitude shrinkage of the gasket seal in relation to the sealing surfaces occurs, which causes loss of seal.

### BRIEF DESCRIPTION OF THE DRAWINGS

FIG. 1 is an isometric view of a satellite including a cryogenic cooling device; and

FIG. 2 is an exploded isometric view of a coupler including a metal gasket seal and being applicable for helium cryogenic applications.

### DETAILED DESCRIPTION OF THE EMBODIMENTS

The following discussion of the embodiments of the invention directed to a metal gasket seal having a low elastic modulus, a high yield strength, suitable corrosion resistance and a low coefficient of thermal expansion (CTE) is merely exemplary in nature, and is in no way intended to limit the invention or its applications or uses. For example, the metal gasket seal of the invention will be discussed below as having specific application for cryogenic, helium-tight applications on spacecraft. However, as will be appreciated by those skilled in the art, the gasket seal will have other applications.

As will be discussed in detail below, the present invention proposes a metal gasket seal that has particular application for cryogenic fittings and systems, and particularly cryogenic systems that use helium gas for cooling. The gasket seal of the invention has a number of highly desirable properties including a low elastic modulus, a high yield strength, suitable corrosion resistance and a low CTE. Specific metals that satisfy these requirements include, but are not limited to, titanium (Ti), vanadium (V), zirconium (Zr), erbium (Er), and alloys thereof. Specific titanium alloys having aluminum (Al), V, chromium (Cr) and/or tin (Sn) include, but are not limited to, Ti-6Al-4V, Ti-13V-11Cr-3Al, Ti-15V-3Cr-35n-3Al, and zircalloy, which is an alloy of zirconium, tin and other metals. Each of these metals has an elastic modulus in the range of 0.5-0.7 relative to the coupling material, such as stainless steel, and a CTE in the range of 0.5-0.8 also relative to the coupling material, such as stainless steel. Other possible metals, but less suitable as a result of being chemically unstable in an ambient environment, include the rare earth elements lanthanum, cerium, gadolinium and praseodymium.

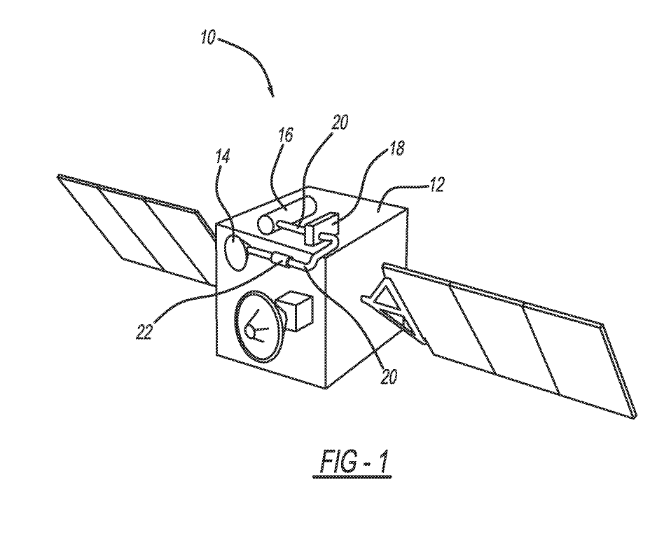

FIG. 1 is an isometric view of a satellite 10, which is intended to generally represent any airborne or spaceborne craft shown to give context to one use of the gasket seal of the invention discussed herein. The spacecraft 10 includes a spacecraft body 12 having a remote sensor 14 extending therefrom, where the sensor 14 is cryogenically cooled. A tank 16 is mounted to the spacecraft body 12 and stores gaseous helium that is sent through a chiller 18 that cools the helium gas close to 4.2 Kelvin (near absolute zero) before it is delivered to the sensor 14. The spacecraft 10 includes a number of pipes 20 that deliver the helium gas from the tank 16 to the sensor 14. The gasket seal discussed herein has particular application to be provided in various joints and fittings 22 that join the pipes 20 to prevent leaking.

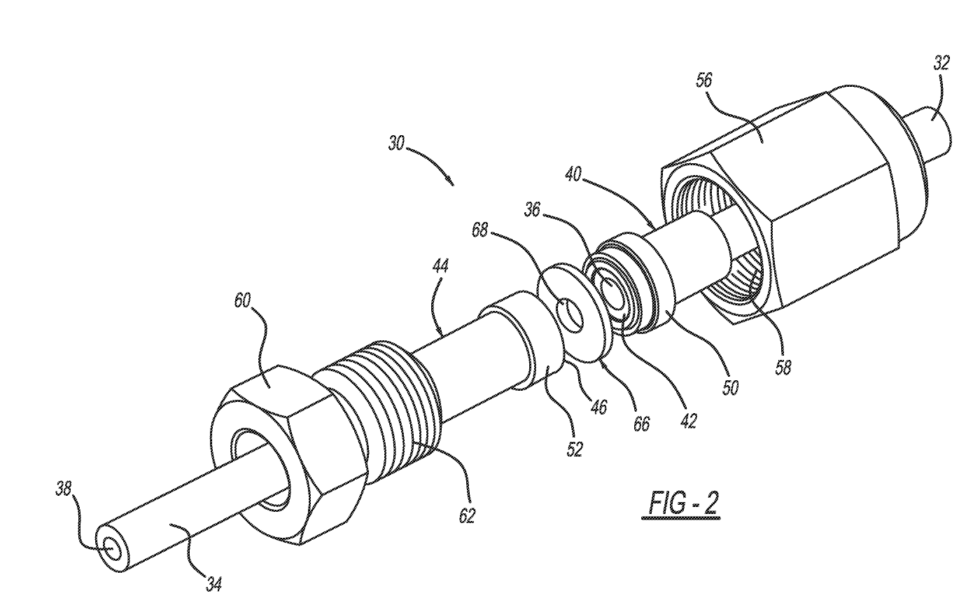

FIG. 2 is an exploded, isometric view of a well known type of coupler 30 that attaches ends of two tubes or pipes 32 and 34, such as stainless steel pipes, in a hermetic leak-tight manner, where a gas, such as a cryogenically cooled helium gas, flows through an internal channel 36 in the pipe 32 and an internal channel 38 in the pipe 34. The coupler 30 is intended to represent any suitable coupler, such as a variable compression ratio (VCR) fitting provided by Swagelok, an AN fitting provided by Fairchild Aerospace, or an OMNISAFE fitting provided by OMNISAFE Inc. The pipe 32 includes a fitting 40 at one open end and has a seal surface 42 and the pipe 34 includes a fitting 44 at one open end and also has a seal surface 46. The fitting 40 includes an annular flange 50 proximate to the seal surface 42 and the fitting 44 includes an annular flange 52 proximate the seal surface 46. A female clamp portion 56 is slidably mounted on the pipe 32 and includes a threaded opening 58, and a male clamp portion 60 is slidably mounted on the pipe 34 and includes a threaded extension 62.

A metal gasket seal 66 having an annular shape with a central circular opening 68 is positioned between the seal surfaces 42 and 46. With the seal 66 in this position, the extension 62 of the male clamping portion 60 is threaded into the opening 58 of the female clamp portion 56 so that an inside structural feature of the female clamp portion 56 pushes against the annular flange 50 and an inside structural feature of the male clamp portion 60 pushes against the annular flange 52 compressing the gasket seal 66 between the seal surfaces 42 and 46 and providing a hermetic helium-tight connection. The size of the gasket seal 66 would be specific for a particular joint and clamping device for the specific application. For example, the gasket seal 66 may have an outer diameter of one quarter of an inch, the opening 68 may be one eighth of an inch in diameter and the thickness of the seal 66 may be 10-30 mils. It is stressed that the coupler 30 is illustrated merely as an example in that the gasket seal 66 of the invention discussed herein can be employed in combination with any suitable coupler.

The gasket seal 66 is fabricated of metal by any suitable metal fabrication process, such as stamping. The metal of the gasket seal 66 can be any of the metals discussed above and/or have any of the properties discussed above for the applications referred to herein. For example, the metal will have a desirable elastic modulus, such as between 0.5 and 0.7 relative to stainless steel, to provide a desirable elastic deformation, and will have a suitable CTE, such as between 0.5 and 0.8 relative to stainless steel, to reduce relative contraction of the seal 66 at cryogenic temperatures. Further, the gasket seal 66 may be fabricated in a particular manner, depending on the particular alloy, to have further desirable properties, such as a high yield strength to minimize plastic deformation and be corrosion resistant. For example, the seal 66 may be heat treated, cold worked or a combination thereof to enhance its yield strength, and may be subjected to a surface treatment, such as passivation, to enhance corrosion resistance, specifically resisting galvanic corrosion. Further, the gasket seal 66 may be mechanically, chemically or electrochemically polished to reduce surface irregularities.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A gasket seal being made of a metal selected from the group consisting of titanium, vanadium, zirconium, erbium and alloys thereof.

2. The gasket seal according to claim 1 wherein the metal is titanium or a titanium alloy.

3. The gasket seal according to claim 2 wherein the metal is a titanium alloy selected from the group consisting of Ti-6Al-4V, Ti-13V-11Cr-3Al and Ti-15V-3Cr-35n-3Al.

4. The gasket seal according to claim 1 wherein the metal is vanadium or a vanadium alloy.

5. The gasket seal according to claim 1 wherein the metal is zirconium or a zirconium alloy.

6. The gasket seal according to claim 5 wherein the metal is zircalloy.

7. The gasket seal according to claim 1 wherein the metal is erbium or an erbium alloy.

8. The gasket seal according to claim 1 wherein the gasket seal has been heat treated, cold worked or a combination thereof to increase its yield strength.

9. The gasket seal according to claim 1 wherein the gasket seal has been polished to reduce its surface irregularities.

10. The gasket seal according to claim 1 wherein the gasket seal has been subjected to a surface treatment to enhance its corrosion resistance.

11. The gasket seal according to claim 10 wherein the surface treatment is passivation.

12. The gasket seal according to claim 1 wherein the gasket seal has an annular shape.

13. The gasket seal according to claim 1 wherein the gasket seal is employed in a fitting for a cryogenic application.

14. The gasket seal according to claim 13 wherein the fitting is a helium gas-tight hermetically sealed fitting.

15. The gasket seal according to claim 13 wherein the cryogenic application is on a spacecraft.

16. A gasket seal being made of metal having an elastic modulus in the range of 0.5-0.7 relative to stainless steel and a coefficient of thermal expansion in the range of 0.5-0.8 relative to stainless steel.

17. The gasket seal according to claim 16 wherein the gasket seal has been heat treated, cold worked or combinations thereof to increase its yield strength.

18. The gasket seal according to claim 16 wherein the gasket seal has been polished to reduce its surface irregularities.

19. The gasket seal according to claim 16 wherein the gasket seal has been subjected to a surface treatment to enhance its corrosion resistance.

20. The gasket seal according to claim 19 wherein the surface treatment is passivation.

21. The gasket seal according to claim 16 wherein the gasket seal has an annular shape.

22. The gasket seal according to claim 16 wherein the gasket seal is employed in a fitting for a cryogenic application.

23. The gasket seal according to claim 22 wherein the fitting is a helium gas-tight hermetically sealed joint.

24. The gasket seal according to claim 22 wherein the cryogenic application is on a spacecraft.

25. A gasket seal employed in a gas-tight hermetically sealed fitting for a cryogenic application, said seal being made of a metal selected from the group of titanium alloys consisting of Ti-6Al-4V, Ti-13V-11Cr-3Al and Ti-15V-3Cr-3Sn-3Al.
